(19) United States
(12) Patent Application Publication
(10) Pub. No.: US 2024/0255620 A1
(43) Pub. Date: Aug. 1, 2024

(54) SEMICONDUCTOR DEVICE HAVING TIME-TO-DIGITAL CONVERTER

(71) Applicant: CANON KABUSHIKI KAISHA, Tokyo (JP)

(72) Inventors: YU MAEHASHI, Hokkaido (JP); KAZUHIRO MORIMOTO, Kanagawa (JP); YUJI NAKAJIMA, Tokyo (JP); HIROYUKI MUTO, Kanagawa (JP)

(21) Appl. No.: 18/427,659

(22) Filed: Jan. 30, 2024

(30) Foreign Application Priority Data
Feb. 1, 2023 (JP) 2023-014111

(51) Int. Cl. G01S 7/4863; G01S 17/931

(52) U.S. Cl. CPC G01S 7/4863; G01S 17/931

(57) ABSTRACT

A semiconductor device includes a plurality of time-to-digital converters each including an input terminal, an output terminal, and a control terminal. A control signal line is connected to the control terminal of a first time-to-digital converter among the plurality of time-to-digital converters, the control terminal of a second time-to-digital converter among the plurality of time-to-digital converters, and the input terminal of the first time-to-digital converter. A control signal propagating through the control signal line is input to the control terminal of the second time-to-digital converter at a time later than a time when the control signal is input to the control terminal of the first time-to-digital converter, and is input to the input terminal of the first time-to-digital converter at a time later than the time when the control signal is input to the control terminal of the second time-to-digital converter.

### BACKGROUND

### Field of the Disclosure

The present disclosure relates to a semiconductor device.

### Description of the Related Art

Japanese Patent Application Laid-Open No. 2020-159921 discloses a light receiving device used in a ranging device for measuring a distance between an object and the light receiving device by a time-of-flight (ToF) method. The light receiving device disclosed in Japanese Patent Application Laid-Open No. 2020-159921 includes a pixel that receives light and a time-to-digital converter (TDC) that measures the time of flight of light. The ranging device disclosed in Japanese Patent Application Laid-Open No. 2020-159921 has a function of performing characteristic evaluation such as differential non-linearity in TDC.

In a semiconductor device having a function of time-to-digital conversion as described in Japanese Patent Application Laid-Open No. 2020-159921, it may be required to acquire information of a systematic error due to other factors.

### SUMMARY

Aspects of the present disclosure provide a semiconductor device capable of suitably acquiring systematic error information.

According to a disclosure of the present specification, there is provided a semiconductor device including: a plurality of time-to-digital converters each including an input terminal, an output terminal, and a control terminal; and a control signal line connected to the control terminal of a first time-to-digital converter among the plurality of time-to-digital converters, the control terminal of a second time-to-digital converter among the plurality of time-to-digital converters, and the input terminal of the first time-to-digital converter. A control signal propagating through the control signal line is input to the control terminal of the second time-to-digital converter at a time later than a time when the control signal is input to the control terminal of the first time-to-digital converter, and is input to the input terminal of the first time-to-digital converter at a time later than the time when the control signal is input to the control terminal of the second time-to-digital converter.

Further features of the present disclosure will become apparent from the following description of embodiments with reference to the attached drawings.

### BRIEF DESCRIPTION OF THE DRAWINGS

FIG. 1 is a block diagram illustrating a configuration example of a photoelectric conversion device according to a first embodiment.

FIG. 2 is a schematic block diagram illustrating a configuration example of one pixel of a photoelectric conversion unit and a pixel signal processing unit according to the first embodiment.

FIGS. 3A, 3B, and 3C are diagrams illustrating the operation of the avalanche photodiode according to the first embodiment.

FIG. 4 is a circuit diagram illustrating a configuration example of a reading circuit according to the first embodiment.

FIG. 5 is a timing chart illustrating an operation of the reading circuit according to the first embodiment.

FIG. 6 is a circuit diagram illustrating a configuration example of a reading circuit according to a second embodiment.

FIG. 7 is a circuit diagram illustrating a configuration example of a reading circuit according to a third embodiment.

FIG. 8 is a timing chart illustrating an operation of the reading circuit according to the third embodiment.

FIGS. 9A, 9B, and 9C are block diagrams illustrating a configuration example of a photoelectric conversion device according to a fourth embodiment.

FIGS. 10A, 10B, and 10C are block diagrams illustrating a configuration example of a photoelectric conversion device according to a fifth embodiment.

FIG. 11 is a block diagram illustrating a configuration example of a photoelectric conversion device according to a sixth embodiment.

FIG. 12 is a block diagram illustrating a configuration example of a photoelectric conversion device according to a seventh embodiment.

FIG. 13 is a block diagram illustrating a configuration example of a photoelectric conversion device according to an eighth embodiment.

FIG. 14 is a schematic diagram illustrating the overall configuration of a photoelectric conversion device according to a ninth embodiment.

FIG. 15 is a block diagram of a photodetection system according to a tenth embodiment.

FIG. 16 is a block diagram of a photodetection system according to an eleventh embodiment.

FIG. 17 is a schematic diagram of an endoscopic surgical system according to a twelfth embodiment.

FIG. 18 is a schematic diagram of a photodetection system according to a thirteenth embodiment.

FIGS. 19A, 19B, and 19C are schematic diagrams of a movable body according to the thirteenth embodiment.

FIG. 20 is a flowchart illustrating an operation of the photodetection system according to the thirteenth embodiment.

FIGS. 21A and 21B are diagrams illustrating a specific example of the electronic device according to a fourteenth embodiment.

### DESCRIPTION OF THE EMBODIMENTS

Embodiments of the present disclosure will now be described with reference to the accompanying drawings. In the following embodiments, the same or corresponding elements are denoted by the same reference numerals, and the description thereof may be omitted or simplified.

### First Embodiment

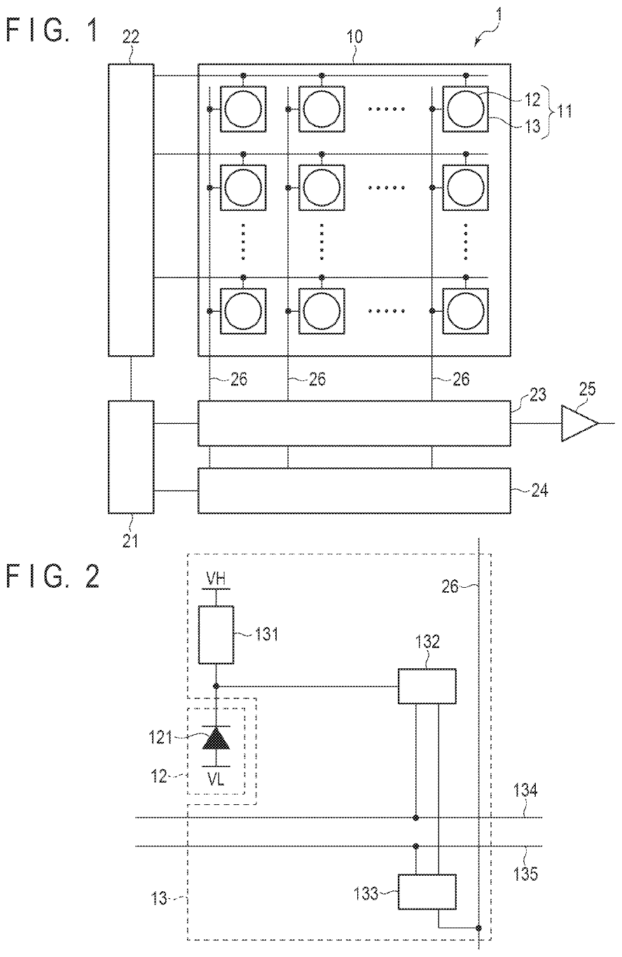

FIG. 1 is a block diagram illustrating a configuration example of a photoelectric conversion device 1 according to the present embodiment. The photoelectric conversion device 1 may be, for example, a solid-state imaging device, a focus detection device, a ranging device, a time-of-flight (ToF) camera, or the like.

The photoelectric conversion device 1 includes a pixel array 10, a control signal generation unit 21, a vertical scanning circuit 22, a reading circuit 23, a horizontal scanning circuit 24, and an output circuit 25. The pixel array 10 includes a plurality of pixels 11 arranged to form a plurality of rows and a plurality of columns. Each of the plurality of pixels 11 includes a photoelectric conversion unit 12 including an avalanche photodiode (hereinafter referred to as APD) and a pixel signal processing unit 13. The photoelectric conversion unit 12 converts incident light into an electric signal. The pixels 11 in each column are provided for each column, and are connected to a pixel output signal line 26 extending in the column direction. The pixel signal processing unit 13 outputs the converted electric signal to the reading circuit 23 via the pixel output signal line 26 in the corresponding column. Note that the row direction indicates the left and right directions in FIG. 1, and the column direction indicates the up and down directions in FIG. 1.

The control signal generation unit 21 is a control circuit that generates control signals for driving the vertical scanning circuit 22, the reading circuit 23, and the horizontal scanning circuit 24, and supplies the control signals to these units. As a result, the control signal generation unit 21 controls the driving timing and the like of each unit.

The vertical scanning circuit 22 supplies the control signal to each of the plurality of pixels 11 based on the control signal supplied from the control signal generation unit 21. The vertical scanning circuit 22 is provided for each row, and supplies control signal to the pixel 11 for each row via driving lines extending in the row direction. As will be described later, a plurality of driving lines may be provided for each row. A logic circuit such as a shift register or an address decoder can be used for the vertical scanning circuit 22. Thereby, the vertical scanning circuit 22 selects a row to be output from the pixel signal processing unit 13.

The horizontal scanning circuit 24 supplies a control signal to the reading circuit 23 based on the control signal supplied from the control signal generation unit 21. Thereby, the horizontal scanning circuit 24 sequentially selects columns for outputting signals from the reading circuit 23. A logic circuit such as the shift register or the address decoder may be used for the horizontal scanning circuit 24. The reading circuit 23 outputs a signal of a selected column to an external storage unit or signal processing unit of the photoelectric conversion device 1 via the output circuit 25.

The pixel 11 may be arranged one-dimensionally. Further, the pixel signal processing unit 13 does not necessarily have to be provided one by one in all the pixels 11. For example, one pixel signal processing unit 13 may be shared by a plurality of pixels 11. In this case, the pixel signal processing unit 13 sequentially processes the signals output from the plurality of photoelectric conversion units 12, thereby providing a function of signal processing to the plurality of pixels 11.

FIG. 2 is a schematic block diagram illustrating a configuration example of one pixel of the photoelectric conversion unit 12 and the pixel signal processing unit 13 according to the present embodiment. In FIG. 2, driving lines between a vertical scanning circuit 22 and the pixel signal processing unit 13 in FIG. 1 are illustrated as driving lines 134 and 135.

The photoelectric conversion unit 12 includes an APD 121. The pixel signal processing unit 13 includes a quenching element 131, a waveform shaping unit 132, and a selection circuit 133. The pixel signal processing unit 13 may include at least one of the waveform shaping unit 132 and the selection circuit 133.

The APD 121 generates charges corresponding to incident light by photoelectric conversion. A voltage VL (first voltage) is supplied to the anode of the APD 121. The cathode of the APD 121 is connected to the first terminal of the quenching element 131 and an input terminal of the waveform shaping unit 132. A voltage VH (second voltage) higher than the voltage VL supplied to the anode of the APD 121 is supplied to the second terminal of the quenching element 131. As a result, a reverse bias voltage that causes the APD 121 to perform the avalanche multiplication operation is supplied to the anode and the cathode of the APD 121. In the APD 121 to which the reverse bias voltage is supplied, when a charge is generated by the incident light, this charge causes avalanche multiplication, and an avalanche current is generated.

The operation modes in the case where a reverse bias voltage is supplied to the APD 121 include a Geiger mode and a linear mode. The Geiger mode is a mode in which the APD 121 operates with a potential difference between the anode and the cathode larger than a breakdown voltage. The linear mode is a mode in which the APD 121 operates with a potential difference between the anode and the cathode near or lower than the breakdown voltage. The APD 121 may operate in the linear mode or the Geiger mode.

The APD operated in the Geiger mode is referred to as a single photon avalanche diode (SPAD). In this case, for example, the voltage VL (first voltage) is −30 V, and the voltage VH (second voltage) is 1 V.

The quenching element 131 has a function of converting a change in the avalanche current generated in the APD 121 into a voltage signal. The quenching element 131 functions as a load circuit (quenching circuit) when a signal is multiplied by avalanche multiplication. The quenching element 131 suppresses the voltage supplied to the APD 121 and suppresses the avalanche multiplication (quenching operation). The quenching element 131 may be, for example, a resistive element.

The waveform shaping unit 132 shapes the potential change of the cathode of the APD 121 obtained at the time of photon detection, and outputs a pulse signal. For example, an inverter circuit or a monostable circuit is used as the waveform shaping unit 132. The waveform shaping unit 132 may be controlled by a control signal input from the vertical scanning circuit 22 via the drive line 134. For example, when the waveform shaping unit 132 is a monostable circuit, the shape of the output waveform of the waveform shaping unit 132 may be selectable by the control signal input via the drive line 134.

The selection circuit 133 is supplied with the control signal from the vertical scanning circuit 22 illustrated in FIG. 1 via a driving line 135 illustrated in FIG. 2. In accordance with this control signal, the selection circuit 133 electrically switches a connected state and a non-connected state between the waveform shaping unit 132 and the pixel output signal line 26. The selection circuit 133 includes, for example, a buffer circuit for outputting a signal according to the output of the waveform shaping unit 132.

In the example of FIG. 2, the selection circuit 133 electrically switches between the connected state and the non-connected state of the waveform shaping unit 132 and the pixel output signal line 26, but the method of controlling the signal output to the pixel output signal line 26 is not limited thereto. For example, a switch such as a transistor may be arranged at a node such as between the quenching element 131 and the APD 121 or between the photoelectric conversion unit 12 and the pixel signal processing unit 13, and the signal output to the pixel output signal line 26 may be controlled by switching the electrical connection and the non-connection. Alternatively, the signal output to the pixel output signal line 26 may be controlled by changing the value of the voltage VH or the voltage VL supplied to the photoelectric conversion unit 12 using a switch such as a transistor.

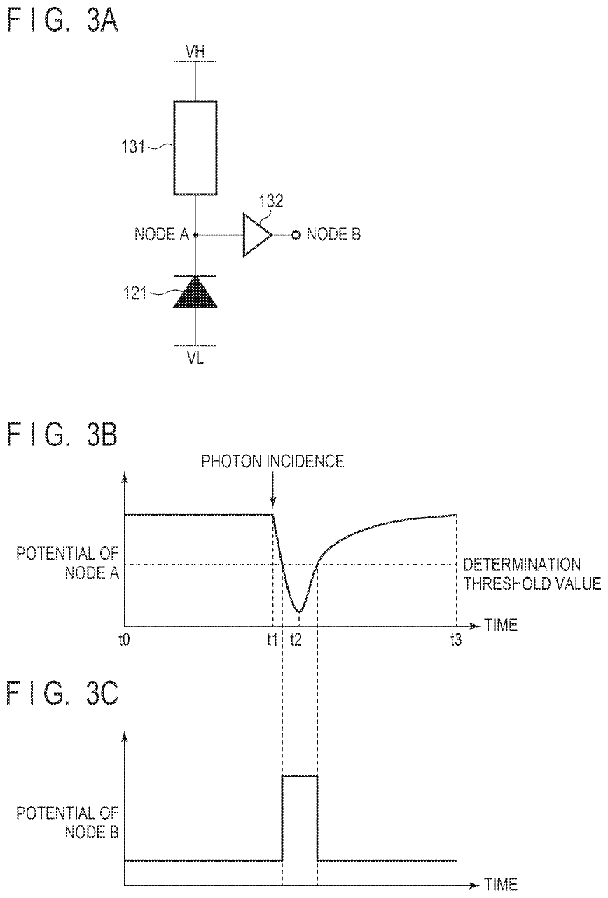

FIGS. 3A, 3B, and 3C are diagrams illustrating an operation of the APD 121 according to the present embodiment. FIG. 3A is a diagram illustrating the APD 121, the quenching element 131, and the waveform shaping unit 132 in FIG. 2. As illustrated in FIG. 3A, the connection node of the input terminal of the APD 121, the quenching element 131, and the waveform shaping unit 132 is referred to as node A. Further, as illustrated in FIG. 3A, an output side of the waveform shaping unit 132 is referred to as node B.

FIG. 3B is a graph illustrating a temporal change in the potential of node A in FIG. 3A. FIG. 3C is a graph illustrating a temporal change in the potential of node B in FIG. 3A. During the period from a time t0 to a time t1, the voltage VH-VL is applied to the APD 121 in FIG. 3A. When a photon is incident the APD 121 at the time t1, avalanche multiplication occurs in the APD 121. As a result, an avalanche current flows through the quenching element 131, and the potential of the node A drops. Thereafter, the amount of potential drop further increases, and the voltage applied to the APD 121 gradually decreases. Then, at time t2, the avalanche multiplication in the APD 121 stops. Thereby, the voltage level of node A does not drop below a certain constant value. Then, during a period from the time t2 to a time t3, a current that compensates for the voltage drop flows from the node of the voltage VH to the node A, and the node A is settled to the original potential at the time t3.

In the above-described process, the potential of node B becomes high level in a period in which the potential of node A is lower than a certain threshold value. In this way, the waveform of the drop of the potential of the node A caused by the incidence of the photon is shaped by the waveform shaping unit 132 and output as a pulse to the node B.

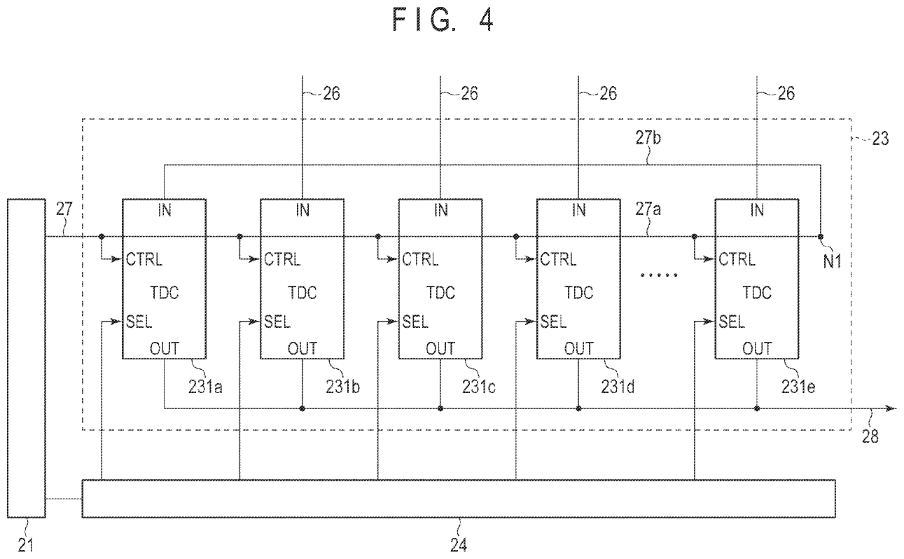

FIG. 4 is a circuit diagram illustrating a configuration example of a reading circuit 23 according to the present embodiment. FIG. 4 illustrates the control signal generation unit 21, the reading circuit 23, and the horizontal scanning circuit 24 extracted from the photoelectric conversion device 1 illustrated in FIG. 1. FIG. 4 illustrates a more detailed configuration of the reading circuit 23.

The reading circuit 23 is a semiconductor device including a plurality of time-to-digital converters (hereinafter referred to as TDCs) each having a function of performing time-to-digital conversion. The reading circuit 23 includes a plurality of TDCs 231a to 231e arranged in one direction. Each of the plurality of TDCs 231a to 231e includes an input terminal IN, an output terminal OUT, a control terminal CTRL, and a selection terminal SEL. Each of the plurality of TDCs 231a to 231e is a circuit that converts input time of a pulse to the input terminal IN into a digital signal and outputs the digital signal from the output terminal OUT. The plurality of TDCs 231b to 231e are arranged to correspond to a plurality of columns of the pixel array 10, respectively. Each input terminal IN of the plurality of TDCs 231b to 231e is connected to a pixel output signal line 26 of a corresponding column.

The reading circuit 23 is provided with a control signal line 27 for transmitting a control signal output from the control signal generation unit 21. The control signal line 27 includes a first part 27a extending from the control signal generation unit 21 toward a node N1 in a row direction, and a second part 27b extending from the node N1 so as to be folded back in a direction opposite to the first part 27a. The control signal line 27 is connected to each of the control terminals CTRL of the plurality of TDCs 231a to 231e in the first part 27a. The control signal line 27 is connected to the input terminal IN of the TDC 231a in the second part 27b.

The plurality of TDCs 231a to 231e are controlled by a control signal transmitted from the control signal generation unit 21 via the control signal line 27. The control signal output from the control signal generation unit 21 propagates through the first part 27a, which is a forward path of the control signal line 27, passes through the node N1, and propagates through a second part 27b, which is a backward path of the control signal line 27. That is, the control signal propagating through the first part 27a is sequentially input to the control terminals CTRL of the plurality of TDCs 231b to 231e (second time-to-digital converter) at times later than a time when the control signal is input to the control terminal CTRL of the TDC 231a (first time-to-digital converter). At the subsequent time, the control signal propagates through the second part 27b and is input to the input terminal IN of the TDC 231a.

The control signal line 27 may be configured with a plurality of parallel signal lines, and the control signals may also be of a plurality of types. The plurality of types of control signals may include, for example, a measurement start signal for controlling time at which the plurality of TDCs 231a to 231e start measurement, or a clock signal indicating a reference in time measurement performed by the plurality of TDCs 231a to 231e.

Each output terminal OUT of the plurality of TDCs 231a to 231e is connected to an output line 28. The output line 28 is connected to the input terminal of the output circuit 25 illustrated in FIG. 1.

A selection terminal SEL of each of the plurality of TDCs 231a to 231e is connected to the horizontal scanning circuit 24. The TDC selected by the control signal from the horizontal scanning circuit 24 outputs a digital signal to the outside of the photoelectric conversion device 1 through the output line 28 and the output circuit 25.

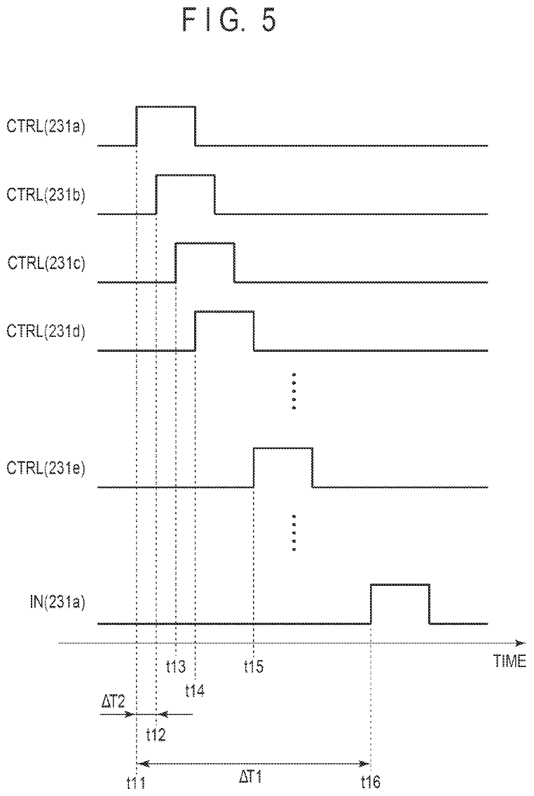

FIG. 5 is a timing chart illustrating the operation of the reading circuit 23 according to the present embodiment. The operation of the reading circuit 23 will be described with reference to FIG. 5. In FIG. 5, “CTRL (231a)” to “CTRL (231e)” respectively indicate input timings of control signals toward the control terminals CTRL of the TDCs 231a to 231e. “IN (231a)” in FIG. 5 indicates the input timing of the control signal to the input terminal IN of the TDC 231a.

At time t11, the control signal input to the control terminal CTRL of the TDC 231a changes from low level to high level. That is, the time t11 is a time at which the rising edge of the control signal propagating through the first part 27a of the control signal line 27 reaches the control terminal CTRL of the TDC 231a.

Similarly, at times t12, t13, t14, and t15, the control signals input to the control terminals CTRL of the TDCs 231b, 231c, 231d, and 231e change from low level to high level, respectively. That is, times t12, t13, t14, and t15 are times at which the rising edge of the control signal propagating through the first part 27a of the control signal line 27 reaches the control terminals CTRL of the TDCs 231b, 231c, 231d, and 231e. A length of the control signal line 27 between the control signal generation unit 21 and the control terminal CTRL of the TDC 231b is longer than the length of the control signal line 27 between the control signal generation unit 21 and the control terminal CTRL of the TDC 231a. Accordingly, the time t12 is a time after the time t11. For the same reason, the time t13 is a time after the time t12, the time t14 is a time after the time t13, and the time t15 is a time after the time t14.

At a time t16, the control signal input to the input terminal IN of the TDC 231a changes from low level to high level. That is, the time t16 is a time at which the rising edge of the control signal propagating through the second part 27b of the control signal line 27 reaches the input terminal IN of the TDC 231a. The length of the control signal line 27 between the control signal generation unit 21 and the input terminal IN of the TDC 231a is longer than any length of the control signal line 27 between the control signal generation unit 21 and the control terminals CTRL of the TDCs 231a to 231e. Accordingly, the time t16 is a time after the time t15.

Thus, an arrival times of the control signals toward each control terminals of the plurality of TDCs 231b to 231e are different from each other. This difference in the arrival time may be an error factor in the time-to-digital conversion of pixel signals performed in the plurality of TDCs 231b to 231e. The reason why the difference of the arrival times occurs is a propagation delay of the control signal in the control signal line 27. Therefore, this error is a systematic error and can be corrected by measuring this delay time.

The same control signal is input to the control terminal CTRL of the TDC 231a and the input terminal IN of the TDC 231a at different times. The difference of the arrival times corresponds to the difference of arrival times ΔT1 between t16 and t11. Thus, the TDC 231a outputs a digital signal (first digital signal) corresponding to the difference of arrival times ΔT1. This digital signal includes systematic error information due to propagation delay in the control signal line 27.

Therefore, the systematic error component can be extracted in real time by processing the digital signal output from the TDC 231a in the signal processing circuit at a following stage to the reading circuit 23. It is also possible to perform real-time correction of the systematic error component in the signal processing circuit as necessary. Further, the output of the digital signal from the TDC 231a can be performed in parallel with the output of the digital signal (the second digital signal) from the plurality of TDCs 231b to 231e. Accordingly, the digital signal output from the TDC 231a may include systematic error information that also follows systematic error factors that may dynamically change, such as a power supply voltage and a temperature.

As described above, the reading circuit 23 of the present embodiment includes the TDC 231a that acquires an information of the systematic error in the TDCs 231b to 231e. Therefore, according to the present embodiment, the semiconductor device capable of appropriately acquiring information of the systematic error is provided.

In FIG. 4, the control signal line 27 is connected to the input terminal IN of the TDC 231a via all the connection nodes of the control terminals CTRL of the TDCs 231a to 231e. For example, the control signal line 27 may be configured to be connected to the input terminal IN of the TDC 231a via only the connection node of the control terminals CTRL of the TDC 231a and the TDC 231b. The control signal line 27 may be configured to be connected to the input terminal IN of the TDC 231a via connection nodes of the control terminals CTRL of the TDC 231a and a part of the TDCs 231b to 231e.

Further, a buffer may be arranged in the middle of the control signal line 27, thereby improving a quality of the waveform of the control signal propagating through the control signal line 27. In this case, it is desirable to arrange the buffer so that the signal delay caused by the buffer is not included in the time measurement result of the TDC 231a as much as possible. Further, it is desirable to arrange the buffers such that delay time caused by the buffers is equal over the entire control signal line 27.

### Second Embodiment

In a present embodiment, a modification of the configuration of the reading circuit 23 of the first embodiment will be described. In the present embodiment, the description of elements common to those of the first embodiment may be omitted or simplified.

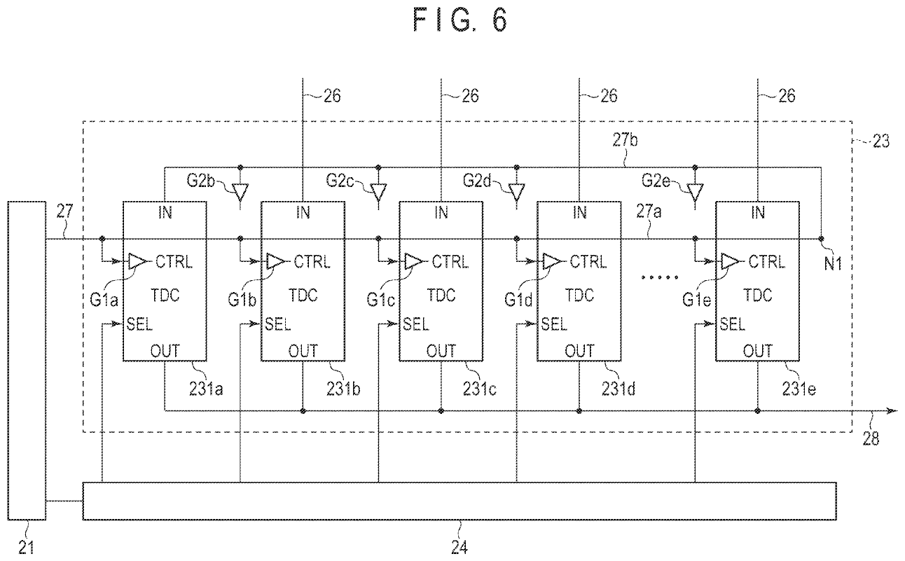

FIG. 6 is a circuit diagram illustrating a configuration example of the reading circuit 23 according to the present embodiment. In the reading circuit 23 of the present embodiment, a plurality of dummy gates G2b to G2e (dummy logic circuits) are connected to the second part 27b of the control signal line 27. Further, FIG. 6 illustrates input gates G1a to G1e at the control terminals CTRL of the blocks of the plurality of TDCs 231a to 231e. The input gates G1a to G1e may cause parasitic loads. By arranging the plurality of dummy gates G2b to G2e, the difference between the parasitic load in the first part 27a of the control signal line 27 and the parasitic load in the second part 27b of the control signal line 27 is reduced. Thereby, the difference between the delay time until the control signal passes through the first part 27a of the control signal line 27 and reaches the node N1 and the delay time until the control signal passes through the second part 27b from the node N1 and reaches the input terminal IN of the TDC 231a can be reduced. From a viewpoint of improving an effect of reducing a delay time difference, it is desirable that the sizes of the plurality of dummy gates G2b to G2e are the same as the sizes of the input gates G1a to G1e.

By appropriately arranging the dummy gates G2b to G2e and designing the delay time difference between the first part 27a and the second part 27b sufficiently small, the difference of the arrival times of the control signals input from the plurality of TDCs 231a to 231e can be configured close to constant. Here, as illustrated in FIG. 5, the difference of arrival times of the control signals input to the TDC 231a and the TDC 231b is denoted by ΔT2. When the difference of the arrival times is constant, if the number of columns of the pixel array 10, that is, the number of the plurality of TDCs 231b to 231e is n, it can be approximated as ΔT1=2n×ΔT2. By dividing the difference of the arrival times ΔT1 included in the output signal of the TDC 231a by 2n, the systematic error component of the entire control signal line 27 and the systematic error component between adjacent columns can be calculated.

As described above, the reading circuit 23 of the present embodiment can output systematic error information as in the first embodiment. Further, in the present embodiment, since the difference between the arrival times of the control signals between the plurality of TDCs can be configured close to a constant value, information of the systematic error component between adjacent columns can be further generated in the signal processing circuit. Therefore, according to the present embodiment, a semiconductor device capable of appropriately acquiring information of the systematic error is provided.

### Third Embodiment

In a present embodiment, a modification of the configuration of the reading circuit 23 of the first embodiment will be described. In the present embodiment, the description of elements common to those of the first embodiment may be omitted or simplified.

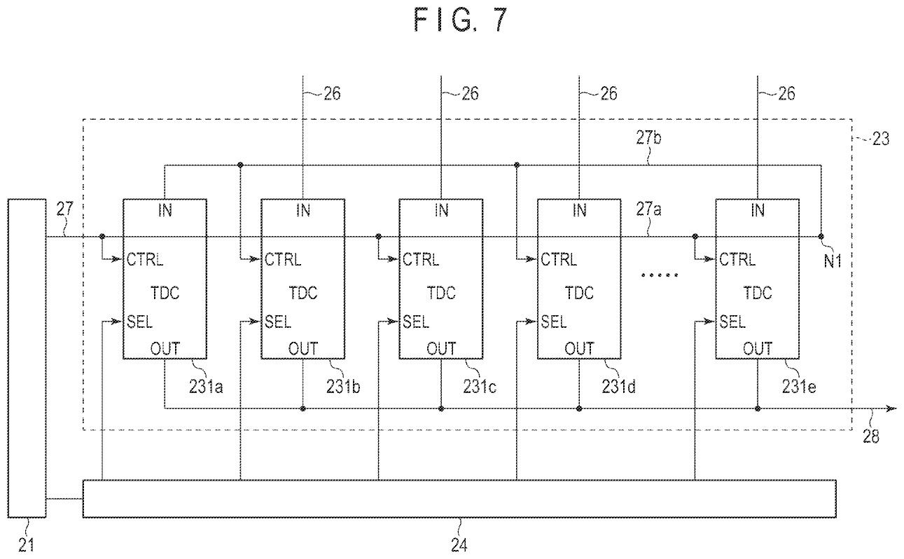

FIG. 7 is a circuit diagram illustrating a configuration example of the reading circuit 23 according to the present embodiment. In the present embodiment, a part of the control terminals CTRL of the plurality of TDCs 231a to 231e is connected to the first part 27a of the control signal line 27, and another part is connected to the second part 27b of the control signal line 27. In the example of FIG. 7, the control terminals CTRL of the TDCs 231a, 231c, and 231e are connected to the first part 27a of the control signal line 27, and the control terminals CTRL of the TDCs 231b and 231d are connected to the second part 27b of the control signal line 27. By connecting the control signal line 27 and the control terminal CTRL in this manner, the difference between the parasitic load in the first part 27a of the control signal line 27 and the parasitic load in the second part 27b of the control signal line 27 is reduced. Thereby, the difference between the delay time until the control signal passes through the first part 27a of the control signal line 27 and reaches the node N1 and the delay time until the control signal passes through the second part 27b from the node N1 and reaches the input terminal IN of the TDC 231a can be reduced.

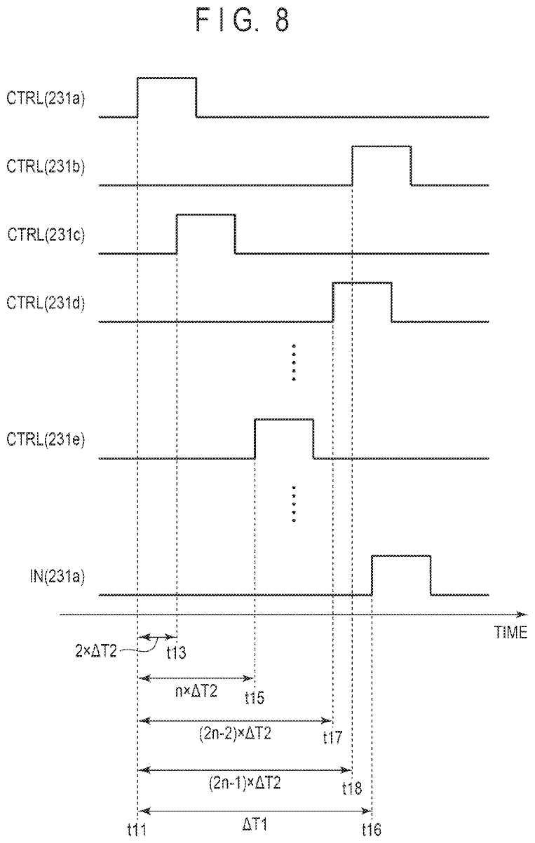

FIG. 8 is a timing chart illustrating an operation of the reading circuit 23 according to the present embodiment. The operation of the reading circuit 23 will be described with reference to FIG. 8. It is assumed that the delay time difference between the first part 27a and the second part 27b is sufficiently small.

At time t17 after the time t15, the control signal input to the control terminal CTRL of the TDC 231d changes from low level to high level. At time t18 after the time t17, the control signal input to the control terminal CTRL of the TDC 231b changes from low level to high level. The other operation timings are the same as those in FIG. 5.

As illustrated in FIG. 8, the difference of arrival times between the control signals input to the TDC 231a and the TDC 231b is (2n−1)×ΔT2, which is smaller than ΔT1 (=2n×ΔT2) by ΔT2. The difference of arrival times between the control signals input to the TDC 231a and the TDC 231c is 2×ΔT2. The difference of arrival time between the control signals input to the TDC 231a and the TDC 231d is (2n−2)×ΔT2. The difference of arrival times between the control signals input to the TDC 231a and the TDC 231e is n×ΔT2.

As described above, in the present embodiment, the delay time difference is different from the physical arrangement of the TDCs 231a to 231e. However, similarly to the second embodiment, the systematic error component of each column can be calculated by multiplying or dividing a predetermined value corresponding to the number of columns from the difference of arrival times ΔT1.

As described above, the reading circuit 23 of the present embodiment can output systematic error information as in the first embodiment. Further, in the present embodiment, the information of the systematic error component of each column can be further generated. Further, in the configuration of the present embodiment, since the dummy gate of the second embodiment is not required, the parasitic load of the control signal line 27 is reduced as compared with the second embodiment, and the effect of saving the area of the pixel array 10 and reducing the power consumption can be obtained.

### Fourth Embodiment

In a present embodiment, modifications of a configurations of the pixel array 10 and the reading circuit 23 of the first embodiment will be described. In the present embodiment, the description of elements common to those of the first embodiment may be omitted or simplified.

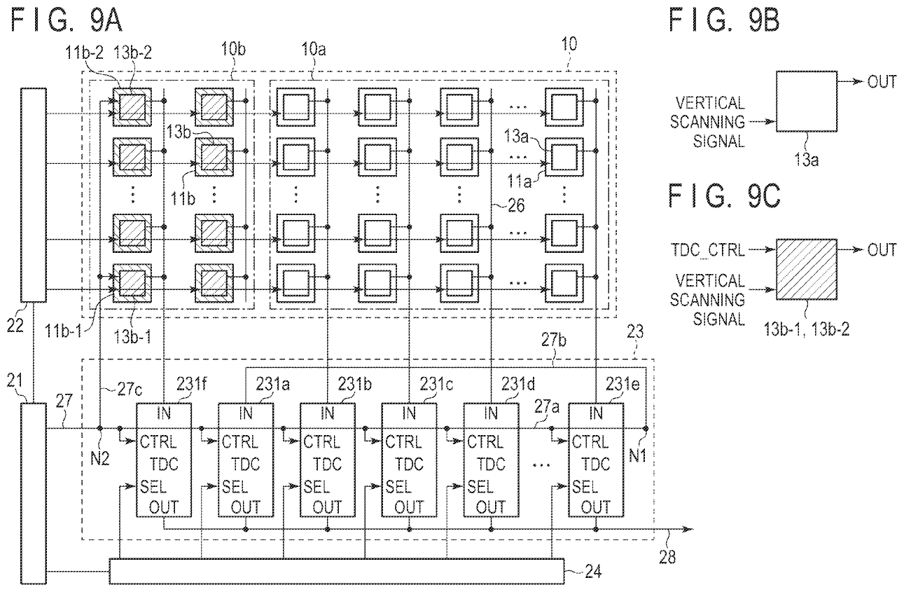

FIGS. 9A, 9B, and 9C are block diagrams illustrating a configuration example of the photoelectric conversion device 1 according to the present embodiment. FIG. 9A illustrates a part of the photoelectric conversion device 1 illustrated in FIG. 1. FIG. 9A illustrates a detailed configuration of the pixel array 10 and the reading circuit 23.

The pixel array 10 includes an effective pixel region 10a and a dummy pixel region 10b. The effective pixel region 10a includes a plurality of effective pixels 11a (first pixel) arranged to form a plurality of rows and a plurality of columns. The effective pixel 11a is similar to the pixel 11 described in the first embodiment, includes a photoelectric conversion unit, and outputs a signal corresponding to incident light. The effective pixel 11a includes a pixel signal processing unit 13a.

The dummy pixel region 10b includes a plurality of dummy pixels 11b (second pixel) arranged to form a plurality of rows. Unlike the effective pixel 11a, the dummy pixel 11b does not output a signal corresponding to the incident light. The dummy pixel 11b may output, for example, a signal corresponding to a control signal that is input. The dummy pixel 11b includes a pixel signal processing unit 13b. In FIG. 9A, the plurality of dummy pixels 11b are arranged in two columns, but it is not limited thereto. The number of columns of the plurality of dummy pixels 11b may be one or more than two.

The reading circuit 23 includes the TDCs 231a to 231e similar to the first embodiment and further includes a TDC 231f (third time-to-digital converter). A first part 27a of the control signal line 27 is connected to the control terminal CTRL of the TDC 231f. The control signal propagating through the first part 27a of the control signal line 27 is input to the control terminal CTRL of the TDC 231f at a time prior to the time when the control signal is input to the control terminal CTRL of the TDC 231a.

The TDC 231f is arranged corresponding to the dummy pixels 11b in one column in the dummy pixel region 10b. The reference numerals of the two dummy pixels of the dummy pixels 11b in the one column are denoted by “−1” and “−2”, respectively, so as to be distinguished from each other. That is, among the dummy pixels 11b of one column, the dummy pixel 11b-1 is that in the row closest to the TDC 231f, and the dummy pixel 11b-2 is that in the row farthest from the TDC 231f. It is assumed that the dummy pixel 11b-1 includes the pixel signal processing unit 13b-1, and the dummy pixel 11b-2 includes the pixel signal processing unit 13b-2.

FIG. 9B is a diagram schematically illustrating input/output signals of a pixel signal processing unit 13a of the effective pixel 11a. A plurality of kinds of control signals (vertical scanning signals) output from the vertical scanning circuit 22 are input to the pixel signal processing unit 13a. The pixel signal processing unit 13a is controlled by a vertical scanning signal and outputs a signal corresponding to the incident light to the pixel output signal line 26.

FIG. 9C is a diagram schematically illustrating input/output signals of the pixel signal processing units 13b-1 and 13b-2 of the dummy pixels 11b-1 and 11b-2. A control signal (TDC_CTRL) output from the control signal generation unit 21 is input to the pixel signal processing units 13b-1 and 13b-2 in addition to the above-described vertical scanning signal. This control signal is the same signal as the signal input to the control terminals CTRL of the plurality of TDCs 231a to 231f. The pixel signal processing units 13b-1 and 13b-2 are controlled by a vertical scanning signal and output a signal corresponding to the control signal to the pixel output signal line 26.

As illustrated in FIG. 9A, the control signal line 27 includes a third part 27c that branches from the first part 27a at a node N2. The third part 27c extends in the column direction from the node N1, and is connected to the pixel signal processing units 13b-1 and 13b-2. The control signal output from the control signal generation unit 21 is input to the pixel signal processing units 13b-1 and 13b-2 via the third part 27c of the control signal line 27. The signals output from the pixel signal processing units 13b-1 and 13b-2 are input to the input terminal IN of the TDC 231f via the pixel output signal line 26. A length of the signal line from the pixel signal processing unit 13b-1 to the TDC 231f is different from a length of the signal line from the pixel signal processing unit 13b-2 to the TDC 231f Therefore, there is the delay time difference between the output signal from the pixel signal processing unit 13b-1 and the output signal from the pixel signal processing unit 13b-2. The TDC 231f can measure this delay time difference. When the number of rows of the dummy pixels 11b is m and the delay time difference measured by the TDC 231f is AT, the delay time difference between adjacent dummy pixels 11b is represented by ΔT/2m.

The reading circuit 23 of the present embodiment further includes the TDC 231f for measuring the delay time between the dummy pixels 11b arranged in the column direction. Thus, according to the present embodiment, as in the first embodiment, the TDC 231a can acquire systematic error information in the row direction, and the TDC 231f can acquire systematic error information due to a propagation delay in the column direction.

The systematic error component in the column direction can be extracted in real time by processing the digital signal output from the TDC 231f in the signal processing circuit at a following stage to the reading circuit 23. It is also possible to perform real-time correction of systematic error component in the column direction in the signal processing circuit as necessary. The signal output from the TDC 231f can be performed in parallel with the time-to-digital conversion in the plurality of TDCs 231b to 231e. Accordingly, the digital signal output from the TDC 231f may include systematic error information that also follows systematic error factors that may dynamically change, such as the power supply voltage and the temperature.

As described above, the reading circuit 23 of the present embodiment can acquire the systematic error information in the row direction and the column direction. Therefore, according to the present embodiment, the semiconductor device capable of appropriately acquiring information of the systematic error is provided.

In FIG. 9A, the TDC 231f is arranged on the left side of the TDC 231a, and the dummy pixel region 10b is arranged on the left side of the effective pixel region 10a but an arrangement of the TDC 231f and the dummy pixel region 10b is not limited thereto. For example, the TDC 231f may be arranged on the right side of the TDC 231e, and the dummy pixel region 10b may be arranged on the right side of the effective pixel region 10a.

### Fifth Embodiment

In a present embodiment, a modification of a configuration of the photoelectric conversion device 1 of the fourth embodiment will be described. In this embodiment, the description of elements common to those of the fourth embodiment may be omitted or simplified.

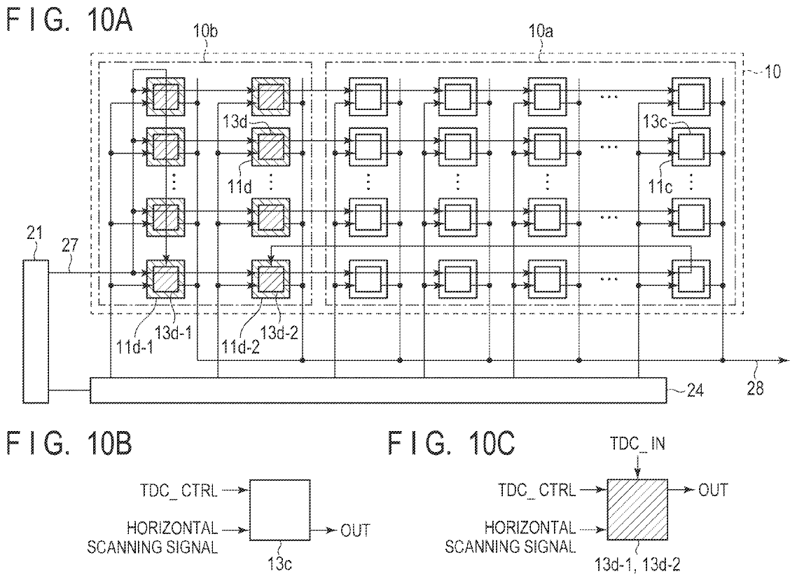

FIGS. 10A, 10B, and 10C are block diagrams illustrating the configuration example of the photoelectric conversion device 1 according to the present embodiment. In the present embodiment, the photoelectric conversion device 1 does not include the vertical scanning circuit 22 and the reading circuit 23 in the fourth embodiment, and each pixel has a TDC function of the reading circuit 23. In other words, each pixel includes the same TDC as described in the above embodiment, and each pixel performs time measurement by time-to-digital conversion.

The effective pixel region 10a includes a plurality of effective pixels 11c arranged to form a plurality of rows and a plurality of columns. The effective pixel 11c includes a pixel signal processing unit 13c. The dummy pixel region 10b includes a plurality of dummy pixels lid arranged to form a plurality of rows and a plurality of columns. The plurality of dummy pixels lid include a dummy pixel lid-1 for a systematic error acquisition in the column direction and a dummy pixel 11d-2 for the systematic error acquisition in the row direction. The dummy pixel 11d-1 includes a pixel signal processing unit 13d-1, and the dummy pixel 11d-2 includes a pixel signal processing unit 13d-2.

FIG. 10B is a diagram schematically illustrating input/output signals of the pixel signal processing unit 13c of the effective pixel 11c. A control signal (TDC_CTRL) output from the control signal generation unit 21 is input to the pixel signal processing unit 13c. By the time-to-digital conversion based on the control signal and the incident light, the effective pixel 11c generates a signal corresponding to the incident time of the light. A control signal (horizontal scanning signal) output from the horizontal scanning circuit 24 is input to the pixel signal processing unit 13c. The pixel signal processing unit 13c is controlled by a horizontal scanning signal and outputs a generated signal.

FIG. 10C is a diagram schematically illustrating input/output signals of the pixel signal processing units 13d-1 and 13d-2 of the dummy pixels lid-1 and 11d-2. To the pixel signal processing units 13d-1 and 13d-2, in addition to the above-described horizontal scanning signal and the control signal (TDC_CTRL) output from the control signal generation unit 21, a control signal (TDC_IN) that passes through a control signal line 27 that reciprocates the pixel array 10 in the row direction or the column direction is input. The pixel signal processing units 13d-1 and 13d-2 are controlled by horizontal scanning signals, and output signals corresponding to a time difference between a control signal (TDC_CTRL) and a control signal (TDC_IN).

The dummy pixel lid-1 is used for measuring the delay time of the control signal line 27 in the column direction. The control signal is input to the input terminal of the dummy pixel lid-1 via the control signal line 27 that reciprocates in the column direction between the lower end and the upper end of the pixel array 10. Thereby, the dummy pixel 11d-1 can acquire the systematic error information due to the propagation delay in the column direction by the same method as in the fourth embodiment. Further, the delay time difference between the dummy pixels 11b adjacent to each other in the column direction can be calculated based on the number of rows of the pixel array 10 and the delay time difference.

The dummy pixel 11d-2 is used for measuring the delay time of the control signal line 27 in the row direction. A control signal is input to the input terminal of the dummy pixel 11d-2 via a control signal line 27 that reciprocates in the row direction between the left end and the right end of the pixel array 10. Thereby, the dummy pixel 11d-2 can acquire the systematic error information due to the propagation delay in the row direction by the same method as in the fourth embodiment. Further, the delay time difference between the dummy pixels 11b adjacent in the row direction can be calculated based on the number of columns of the pixel array 10 and the delay time difference.

As described above, even in the configuration in which each pixel has a TDC function and the reading circuit 23 is omitted as in the present embodiment, the systematic error information in the row direction and the column direction can be acquired as in the fourth embodiment. Therefore, according to the present embodiment, the semiconductor device capable of appropriately acquiring information of a systematic error is provided.

Although the example in which all the pixels have the TDC function is described in the present embodiment, one circuit having the TDC function may be arranged for each pixel block including a plurality of pixels. The signal input to the input terminal of the dummy pixel lid-1 may be the output signal of any one of the dummy pixels 11d instead of the control signal (TDC_IN) via the control signal line 27.

### Sixth Embodiment

In a present embodiment, a modification of a configuration of the photoelectric conversion device 1 of the fifth embodiment will be described. In this embodiment, the description of elements common to those of the fifth embodiment may be omitted or simplified.

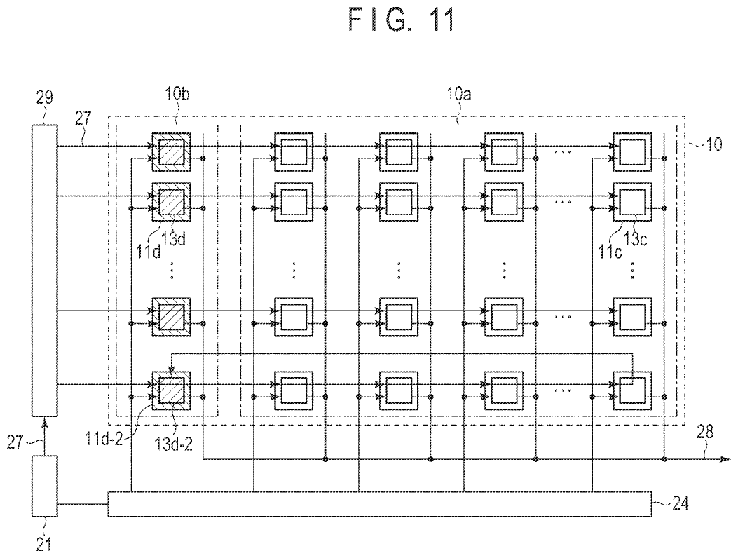

FIG. 11 is a block diagram illustrating a configuration example of the photoelectric conversion device 1 according to the present embodiment. In the present embodiment, the photoelectric conversion device 1 is further provided with a tree wiring 29. The tree wiring 29 includes a circuit such as a buffer, and has a function of distributing the control signal line 27 to multiple parallel lines. The control signal line 27 distributed by the tree wiring 29 is arranged to correspond to each row of the pixel array 10. By arranging the tree wiring 29, the delay time in the column direction is reduced, and the systematic error caused by the propagation delay in the column direction is reduced. In this case, the acquisition of the systematic error information in the column direction as described in the fifth embodiment may be omitted. In the example of FIG. 11, the dummy pixel 11d-1 used for acquiring the systematic error information in the column direction is omitted. Therefore, the number of columns of dummy pixels can be reduced.

Even in the configuration in which the systematic error in the column direction is reduced by arranging the tree wiring 29 as in the present embodiment, the systematic error in the row direction can be acquired as in the fifth embodiment. Therefore, according to the present embodiment, the semiconductor device capable of appropriately acquiring information of the systematic error is provided.

### Seventh Embodiment

In a present embodiment, a modification of a configuration of the photoelectric conversion device 1 of the fifth embodiment will be described. In this embodiment, the description of elements common to those of the fifth embodiment may be omitted or simplified.

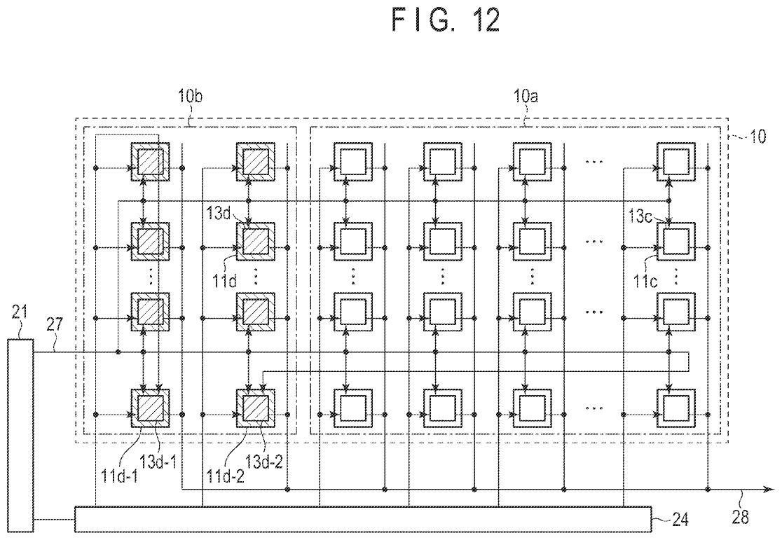

FIG. 12 is a block diagram illustrating a configuration example of the photoelectric conversion device 1 according to the present embodiment. In the fifth embodiment, the control signal output from the control signal generation unit 21 is supplied to the effective pixel 11c and the dummy pixel 11d via the control signal line arranged in each row. On the other hand, in the present embodiment, as illustrated in FIG. 12, the control signals output from the control signal generation unit 21 are supplied to the effective pixel 11c and the dummy pixel 11d via the control signal lines arranged one for every two rows. Thereby, the number of control signal lines in the row direction can be reduced, and the area of the pixel array 10 can be saved.

Also in this embodiment, the semiconductor device capable of appropriately acquiring systematic error information is provided as in the fifth embodiment. Further, in the present embodiment, by reducing the number of control signal lines, the area of the pixel array 10 can be saved.

### Eighth Embodiment

In a present embodiment, a modification of a configuration of the photoelectric conversion device 1 of the fifth embodiment will be described. In this embodiment, the description of elements common to those of the fifth embodiment may be omitted or simplified.

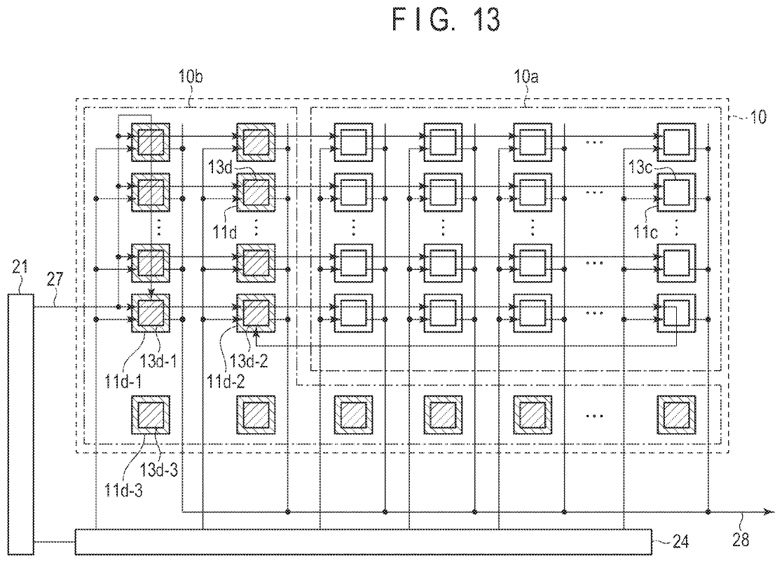

FIG. 13 is a block diagram illustrating a configuration example of the photoelectric conversion device 1 according to the present embodiment. In the present embodiment, as illustrated in FIG. 13, all the pixels in the bottommost row are included in the dummy pixel region 10b. The bottommost dummy pixel 11d-3 includes a pixel signal processing unit 13d-3. The pixel signal processing unit 13d-3 is connected to neither the control signal generation unit 21 nor the horizontal scanning circuit 24 by wiring, and does not have the function of outputting a signal. By arranging the dummy pixel 11d-3, parasitic capacitance between the control signal line 27 and peripheral circuit is reduced. As a result, a crosstalk or the like can be reduced, and noise contained in the output signal from the pixel in the effective pixel region 10a due to the parasitic capacitance of the control signal line 27 is reduced.

Also in this embodiment, the semiconductor device capable of appropriately acquiring systematic error information is provided as in the fifth embodiment. In the present embodiment, since the dummy pixel 11d-3 is arranged, the quality of the output signal can be improved.

### Ninth Embodiment

In a present embodiment, an example of a structure of the photoelectric conversion device 1, which can be applied to the above embodiments will be described. In this embodiment, the description of elements common to the first to eighth embodiments may be omitted or simplified.

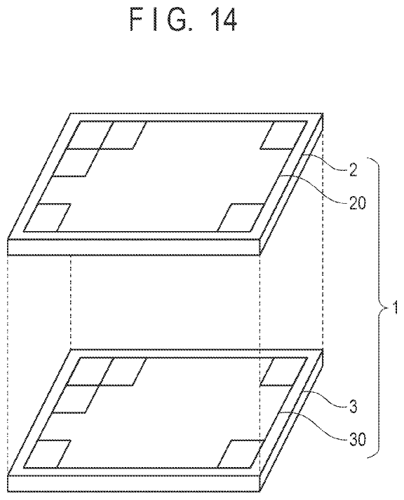

FIG. 14 is a schematic view illustrating the overall configuration of the photoelectric conversion device 1 according to the present embodiment. The photoelectric conversion device 1 includes a sensor substrate 2 (first substrate) and a circuit substrate 3 (second substrate) stacked on each other. The sensor substrate 2 and the circuit substrate 3 are electrically connected to each other. The sensor substrate 2 has a pixel region 20, and the circuit substrate 3 has a circuit region 30. The pixel region 20 includes at least the photoelectric conversion unit 12 in the above-described embodiments. The circuit region 30 includes at least the TDC in the above-described embodiments. The sensor substrate 2 and the circuit substrate 3 may be connected for each pixel, or may be connected for a plurality of pixels in one block, which may be one row or one column. Although FIG. 14 illustrates an example in which two substrates are stacked, the number of substrates stacked may be three or more.

Also in the present embodiment, in addition to the effects similar to those of the above embodiments, the semiconductor device in which area efficiency can be improved by stacking a plurality of substrates is provided. Further, along with the improvement of the area efficiency, effects such as reduction in size and power consumption of the device are obtained.

### Tenth Embodiment

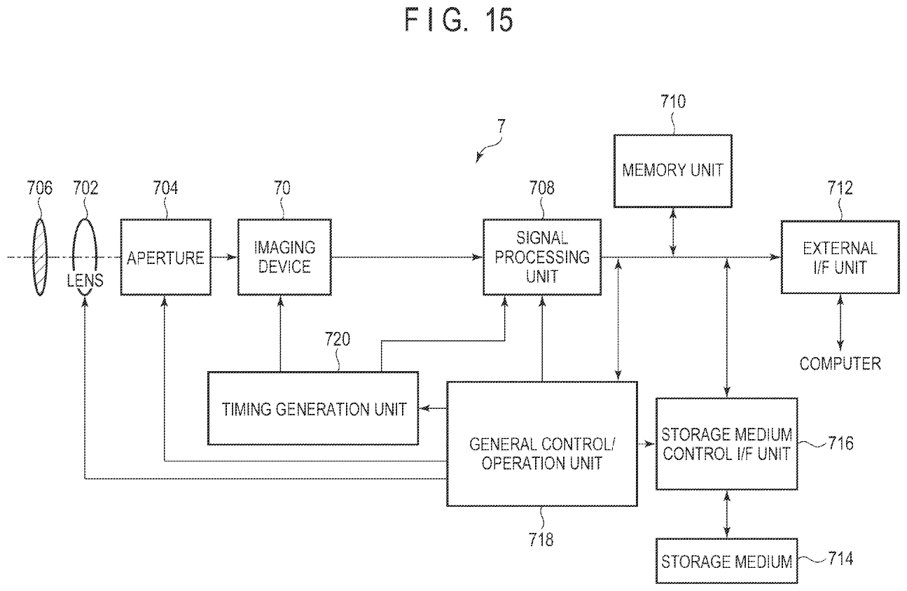

A photodetection system according to a tenth embodiment of the present disclosure will be described with reference to FIG. 15. FIG. 15 is a block diagram of a photodetection system according to the present embodiment. The photodetection system of the present embodiment is an imaging system that acquires an image based on incident light.

The photoelectric conversion device of the above-described embodiment may be applied to various imaging systems. Examples of the imaging system include a digital still camera, a digital camcorder, a camera head, a copying machine, a facsimile, a mobile phone, a vehicle-mounted camera, an observation satellite, and a surveillance camera. FIG. 15 is a block diagram of a digital still camera as an example of an imaging system.

The imaging system 7 illustrated in FIG. 15 includes a barrier 706, a lens 702, an aperture 704, an imaging device 70, a signal processing unit 708, a timing generation unit 720, a general control/operation unit 718, a memory unit 710, a storage medium control I/F unit 716, a storage medium 714, and an external I/F unit 712. The barrier 706 protects the lens, and the lens 702 forms an optical image of an object on the imaging device 70. The aperture 704 varies an amount of light passing through the lens 702. The imaging device 70 is configured as in the photoelectric conversion device of the above-described embodiment, and converts an optical image formed by the lens 702 into image data. The signal processing unit 708 performs various kinds of correction, data compression, and the like on the imaging data output from the imaging device 70.

The timing generation unit 720 outputs various timing signals to the imaging device 70 and the signal processing unit 708. The general control/operation unit 718 controls the entire digital still camera, and the memory unit 710 temporarily stores image data. The storage medium control I/F unit 716 is an interface for storing or reading out image data on the storage medium 714, and the storage medium 714 is a detachable storage medium such as a semiconductor memory for storing or reading out image data. The external I/F unit 712 is an interface for communicating with an external computer or the like. The timing signal or the like may be input from the outside of the imaging system 7, and the imaging system 7 may include at least the imaging device 70 and the signal processing unit 708 that processes an image signal output from the imaging device 70.

In the present embodiment, the imaging device 70 and the signal processing unit 708 may be arranged in the same semiconductor substrate. Further, the imaging device 70 and the signal processing unit 708 may be arranged in different semiconductor substrates.

Further, each pixel of the imaging device 70 may include a first photoelectric conversion unit and a second photoelectric conversion unit. The signal processing unit 708 processes a pixel signal based on a charge generated in the first photoelectric conversion unit and a pixel signal based on a charge generated in the second photoelectric conversion unit, and acquires the distance information from the imaging device 70 to the object.

### Eleventh Embodiment

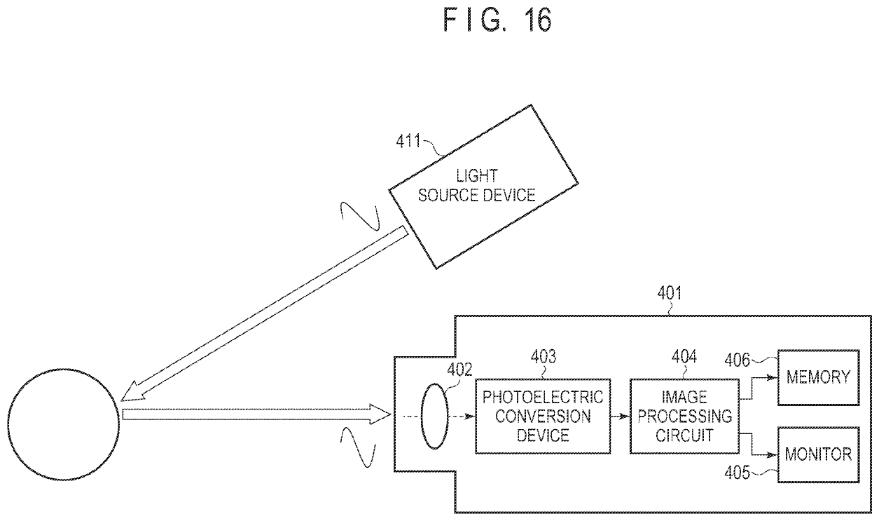

FIG. 16 is a block diagram of a photodetection system according to the present embodiment. More specifically, FIG. 16 is a block diagram of a distance image sensor using the photoelectric conversion device described in the above embodiment.

As illustrated in FIG. 16, the distance image sensor 401 includes an optical system 402, a photoelectric conversion device 403, an image processing circuit 404, a monitor 405, and a memory 406. The distance image sensor 401 receives light (modulated light or pulse light) emitted from the light source device 411 toward an object and reflected by the surface of the object. The distance image sensor 401 can acquire a distance image corresponding to a distance to the object based on a time period from light emission to light reception.

The optical system 402 includes one or a plurality of lenses, and guides image light (incident light) from the object to the photoelectric conversion device 403 to form an image on a light receiving surface (sensor unit) of the photoelectric conversion device 403.

As the photoelectric conversion device 403, the photoelectric conversion device of each of the embodiments described above can be applied. The photoelectric conversion device 403 supplies a distance signal indicating a distance obtained from the received light signal to the image processing circuit 404.

The image processing circuit 404 performs image processing for constructing a distance image based on the distance signal supplied from the photoelectric conversion device 403. The distance image (image data) obtained by the image processing can be displayed on the monitor 405 and stored (recorded) in the memory 406.

The distance image sensor 401 configured in this manner can acquire an accurate distance image by applying the photoelectric conversion device described above.

### Twelfth Embodiment

The technology according to the present disclosure can be applied to various products. For example, the technology according to the present disclosure may be applied to an endoscopic surgical system, which is an example of a photodetection system.

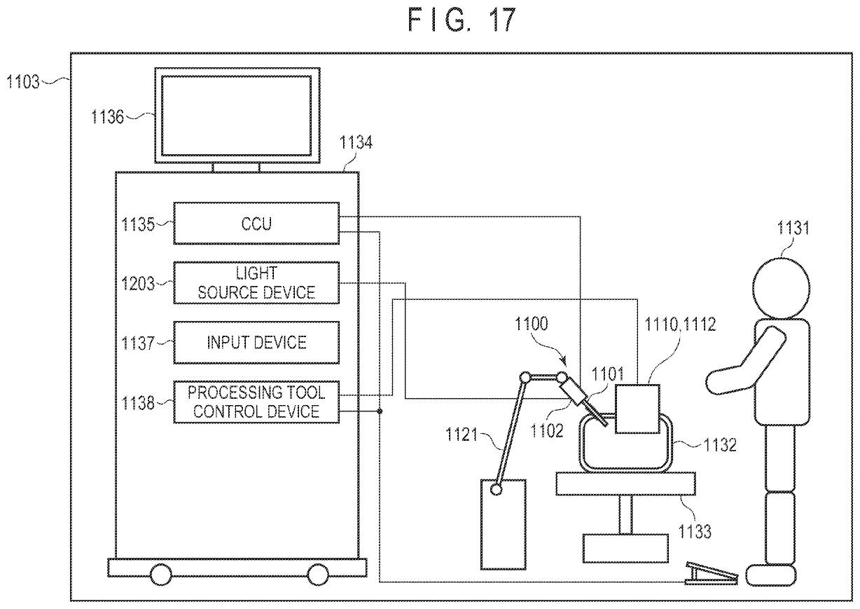

FIG. 17 is a schematic diagram of an endoscopic surgical system according to the present embodiment. FIG. 17 illustrates a state in which an operator (physician) 1131 performs surgery on a patient 1132 on a patient bed 1133 using an endoscopic surgical system 1103. As illustrated, the endoscopic surgical system 1103 includes an endoscope 1100, a surgical tool 1110, an arm 1121, and a cart 1134 on which various devices for endoscopic surgery are mounted.

The endoscope 1100 includes a barrel 1101 in which an area of a predetermined length from the distal end is inserted into a body cavity of a patient 1132, and a camera head 1102 connected to a proximal end of the barrel 1101. FIG. 17 illustrates an endoscope 1100 configured as a rigid scope having a rigid barrel 1101, but the endoscope 1100 may be configured as a flexible scope having a flexible barrel.

An opening into which an objective lens is fitted is provided at the distal end of the barrel 1101. A light source device 1203 is connected to the endoscope 1100. Light generated by the light source device 1203 is guided to the distal end of the barrel 1101 by a light guide extended inside the barrel 1101, and is irradiated to an observation target in the body cavity of the patient 1132 via an objective lens. The endoscope 1100 may be a straight-viewing scope an oblique-viewing scope, or a side-viewing scope.

An optical system and a photoelectric conversion device are provided inside the camera head 1102, and reflected light (observation light) from the observation target is focused on the photoelectric conversion device by the optical system. The observation light is photoelectrically converted by the photoelectric conversion device, and an electric signal corresponding to the observation light, that is, an image signal corresponding to an observation image is generated. As the photoelectric conversion device, the photoelectric conversion device described in each of the above embodiments can be used. The image signal is transmitted to a camera control unit (CCU) 1135 as RAW data.

The CCU 1135 includes a central processing unit (CPU), a graphics processing unit (GPU), and the like, and integrally controls operations of the endoscope 1100 and a display device 1136. Further, the CCU 1135 receives an image signal from the camera head 1102, and performs various types of image processing for displaying an image based on the image signal, such as development processing (demosaic processing).

The display device 1136 displays an image based on the image signal processed by the CCU 1135 under the control of the CCU 1135.

The light source device 1203 includes, for example, a light source such as a light emitting diode (LED), and supplies irradiation light to the endoscope 1100 when capturing an image of a surgical site or the like.

An input device 1137 is an input interface for the endoscopic surgical system 1103. The user can input various types of information and instructions to the endoscopic surgical system 1103 via the input device 1137.

A processing tool control device 1138 controls the actuation of the energy treatment tool 1112 for ablation of tissue, incision, sealing of blood vessels, and the like.

The light source device 1203 can supply irradiation light to the endoscope 1100 when capturing an image of a surgical site, and may be, for example, a white light source such as an LED, a laser light source, or a combination thereof. When a white light source is constituted by a combination of RGB laser light sources, the output intensity and output timing of each color (each wavelength) can be controlled with high accuracy. Therefore, the white balance of the captured image can be adjusted in the light source device 1203. In this case, laser light from each of the RGB laser light sources may be irradiated onto the observation target in a time-division manner, and driving of the imaging element of the camera head 1102 may be controlled in synchronization with the irradiation timing. Thus, images corresponding to R, G, and B can be captured in a time-division manner. According to such a method, a color image can be obtained without providing a color filter in the imaging element.

Further, the driving of the light source device 1203 may be controlled so that the intensity of the light output from the light source device 1203 is changed at predetermined time intervals. By controlling the driving of the imaging element of the camera head 1102 in synchronization with the timing of changing the intensity of light to acquire images in a time-division manner, and by synthesizing the images, it is possible to generate an image in a high dynamic range without so-called black out and white out.

Further, the light source device 1203 may be configured to be capable of supplying light in a predetermined wavelength band corresponding to special light observation. In the special light observation, for example, wavelength dependency of absorption of light in body tissue can be utilized. Specifically, predetermined tissues such as blood vessels in the surface layer of the mucosa are photographed with high contrast by irradiating light in a narrower band compared to the irradiation light (that is, white light) during normal observation. Alternatively, in the special light observation, fluorescence observation for obtaining an image by fluorescence generated by irradiation with excitation light may be performed. In the fluorescence observation, the body tissue can be irradiated with excitation light to observe fluorescence from the body tissue, or a reagent such as indocyanine green (ICG) can be locally injected to the body tissue and the body tissue can be irradiated with excitation light corresponding to the fluorescence wavelength of the reagent to obtain a fluorescence image. The light source device 1203 may be configured to supply narrowband light and/or excitation light corresponding to such special light observation.

### Thirteenth Embodiment

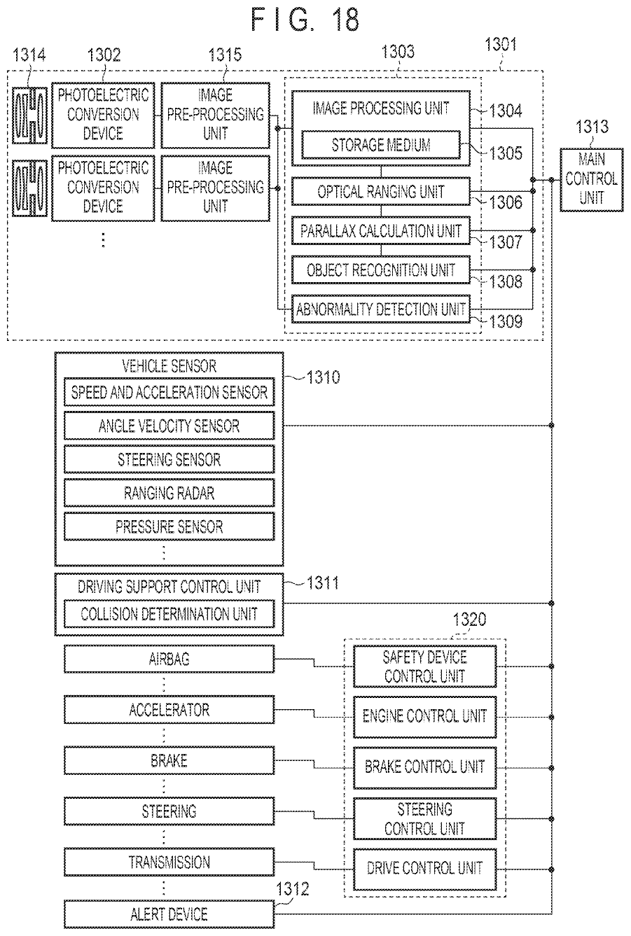

A photodetection system and A movable body of the present embodiment will be described with reference to FIGS. 18, 19A, 19B, 19C, and 20. In the present embodiment, an example of an in-vehicle camera is illustrated as a photodetection system.

FIG. 18 is a schematic diagram of a photodetection system according to the present embodiment, and illustrates an example of a vehicle system and a photodetection system mounted on the vehicle system. The photodetection system 1301 includes photoelectric conversion devices 1302, image pre-processing units 1315, an integrated circuit 1303, and optical systems 1314. The optical system 1314 forms an optical image of an object on the photoelectric conversion device 1302. The photoelectric conversion device 1302 converts the optical image of the object formed by the optical system 1314 into an electric signal. The photoelectric conversion device 1302 is the photoelectric conversion device of any one of the above-described embodiments. The image pre-processing unit 1315 performs predetermined signal processing on the signal output from the photoelectric conversion device 1302. The function of the image pre-processing unit 1315 may be incorporated in the photoelectric conversion device 1302. The photodetection system 1301 is provided with at least two sets of the optical system 1314, the photoelectric conversion device 1302, and the image pre-processing unit 1315, and an output signal from the image pre-processing units 1315 of each set is input to the integrated circuit 1303.

The integrated circuit 1303 is an integrated circuit for use in an imaging system, and includes an image processing unit 1304 including a storage medium 1305, an optical ranging unit 1306, a parallax calculation unit 1307, an object recognition unit 1308, and an abnormality detection unit 1309. The image processing unit 1304 performs image processing such as development processing and defect correction on the output signal of the image pre-processing unit 1315. The storage medium 1305 performs primary storage of captured images and stores defect positions of image capturing pixels. The optical ranging unit 1306 focuses or measures the object. The parallax calculation unit 1307 calculates distance measurement information from the plurality of image data acquired by the plurality of photoelectric conversion devices 1302. The object recognition unit 1308 recognizes an object such as a car, a road, a sign, or a person. When the abnormality detection unit 1309 detects the abnormality of the photoelectric conversion device 1302, the abnormality detection unit 1309 issues an abnormality to the main control unit 1313.

The integrated circuit 1303 may be realized by dedicated hardware, a software module, or a combination thereof. It may be realized by a field programmable gate array (FPGA), an application specific integrated circuit (ASIC), or the like, or may be realized by a combination of these.

The main control unit 1313 controls overall operations of the photodetection system 1301, a vehicle sensor 1310, a control unit 1320, and the like. Without the main control unit 1313, the photodetection system 1301, the vehicle sensor 1310, and the control unit 1320 may individually have a communication interface, and each of them may transmit and receive control signals via a communication network, for example, according to the CAN standard.

The integrated circuit 1303 has a function of transmitting a control signal or a setting value to the photoelectric conversion device 1302 by receiving a control signal from the main control unit 1313 or by its own control unit.

The photodetection system 1301 is connected to the vehicle sensor 1310, and can detect a traveling state of the host vehicle such as a vehicle speed, a yaw rate, a steering angle, and the like, an environment outside the host vehicle, and states of other vehicles and obstacles. The vehicle sensor 1310 is also a distance information acquisition unit that acquires distance information to the object. The photodetection system 1301 is connected to a driving support control unit 1311 that performs various driving support functions such as an automatic steering function, an automatic cruise function, and a collision prevention function. In particular, with regard to the collision determination function, based on detection results of the photodetection system 1301 and the vehicle sensor 1310, it is determined whether or not there is a possibility or occurrence of collision with another vehicle or an obstacle. Thus, avoidance control is performed when a possibility of collision is estimated and a safety device is activated when collision occurs.

The photodetection system 1301 is also connected to an alert device 1312 that issues an alarm to a driver based on a determination result of the collision determination unit. For example, when the possibility of collision is high as the determination result of the collision determination unit, the main control unit 1313 performs vehicle control such as braking, returning an accelerator, suppressing engine output, or the like, thereby avoiding collision or reducing damage. The alert device 1312 issues a warning to a user using means such as an alarm of a sound or the like, a display of alarm information on a display unit screen such as a car navigation system and a meter panel, and a vibration application to a seatbelt and a steering wheel.

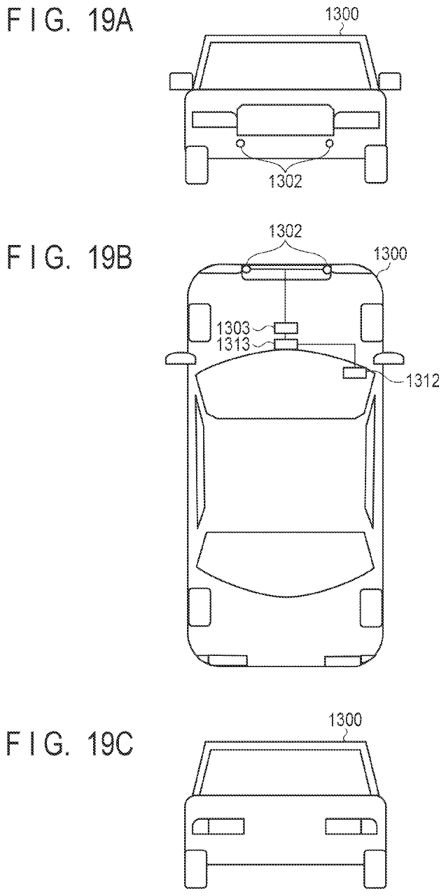

The photodetection system 1301 according to the present embodiment can capture an image around the vehicle, for example, the front or the rear. FIGS. 19A, 19B, and 19C are schematic diagrams of a movable body according to the present embodiment, and illustrate a configuration in which an image of the front of the vehicle is captured by the photodetection system 1301.

The two photoelectric conversion devices 1302 are arranged in front of the vehicle 1300. Specifically, it is preferable that a center line with respect to a forward/backward direction or an outer shape (for example, a vehicle width) of the vehicle 1300 be regarded as a symmetry axis, and two photoelectric conversion devices 1302 be arranged in line symmetry with respect to the symmetry axis. This makes it possible to effectively acquire distance information between the vehicle 1300 and the object to be imaged and determine the possibility of collision. Further, it is preferable that the photoelectric conversion device 1302 be arranged at a position where it does not obstruct the field of view of the driver when the driver sees a situation outside the vehicle 1300 from the driver's seat. The alert device 1312 is preferably arranged at a position that is easy to enter the field of view of the driver.

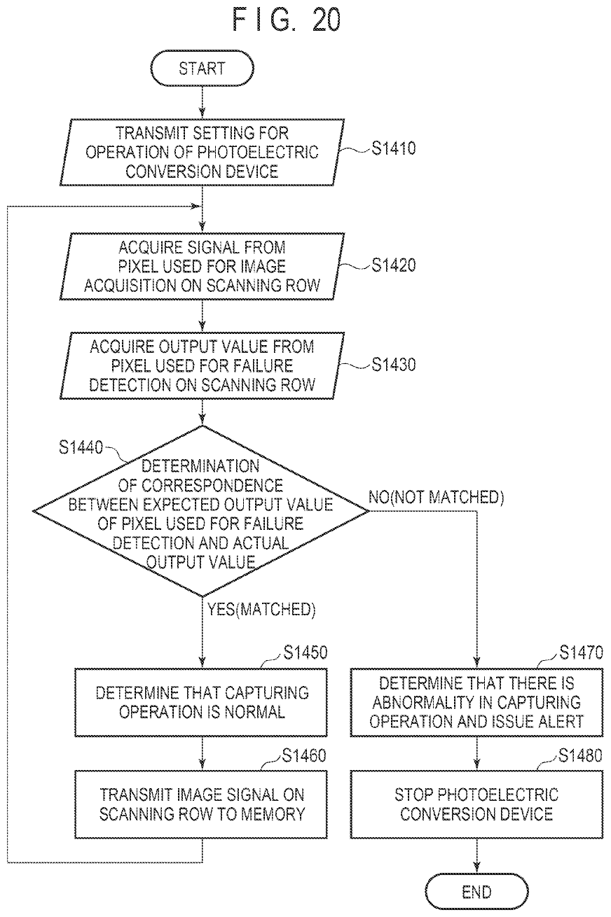

Next, a failure detection operation of the photoelectric conversion device 1302 in the photodetection system 1301 will be described with reference to FIG. 20. FIG. 20 is a flowchart illustrating an operation of the photodetection system according to the present embodiment. The failure detection operation of the photoelectric conversion device 1302 may be performed according to steps S1410 to S1480 illustrated in FIG. 20.

In step S1410, the setting at the time of startup of the photoelectric conversion device 1302 is performed. That is, setting information for the operation of the photoelectric conversion device 1302 is transmitted from the outside of the photodetection system 1301 (for example, the main control unit 1313) or the inside of the photodetection system 1301, and the photoelectric conversion device 1302 starts an imaging operation and a failure detection operation.

Next, in step S1420, the photoelectric conversion device 1302 acquires pixel signals from the effective pixels. In step S1430, the photoelectric conversion device 1302 acquires an output value from a failure detection pixel provided for failure detection. The failure detection pixel includes a photoelectric conversion element in the same manner as the effective pixel. A predetermined voltage is written to the photoelectric conversion element. The failure detection pixel outputs a signal corresponding to the voltage written in the photoelectric conversion element. Steps S1420 and S1430 may be executed in reverse order.

Next, in step S1440, the photodetection system 1301 performs a determination of correspondence between the expected output value of the failure detection pixel and the actual output value from the failure detection pixel. If it is determined in step S1440 that the expected output value matches the actual output value, the photodetection system 1301 proceeds with the process to step S1450, determines that the imaging operation is normally performed, and proceeds with the process to step S1460. In step S1460, the photodetection system 1301 transmits the pixel signals of the scanning row to the storage medium 1305 and temporarily stores them. Thereafter, the process of the photodetection system 1301 returns to step S1420 to continue the failure detection operation. On the other hand, as a result of the determination in step S1440, if the expected output value does not match the actual output value, the photodetection system 1301 proceeds with the process to step S1470. In step S1470, the photodetection system 1301 determines that there is an abnormality in the imaging operation, and issues an alert to the main control unit 1313 or the alert device 1312. The alert device 1312 causes the display unit to display that an abnormality has been detected. Then, in step S1480, the photodetection system 1301 stops the photoelectric conversion device 1302 and ends the operation of the photodetection system 1301.

Although the present embodiment exemplifies the example in which the flowchart is looped for each row, the flowchart may be looped for each plurality of rows, or the failure detection operation may be performed for each frame. The alert of step S1470 may be notified to the outside of the vehicle via a wireless network.

Further, in the present embodiment, the control in which the vehicle does not collide with another vehicle has been described, but the present embodiment is also applicable to a control in which the vehicle is automatically driven following another vehicle, a control in which the vehicle is automatically driven so as not to protrude from the lane, and the like. Further, the photodetection system 1301 can be applied not only to a vehicle such as a host vehicle, but also to a movable body (movable apparatus) such as a ship, an aircraft, or an industrial robot. In addition, the present embodiment can be applied not only to a movable body but also to an apparatus utilizing object recognition such as an intelligent transport systems (ITS).

The photoelectric conversion device of the present disclosure may be a configuration capable of further acquiring various types of information such as distance information.

### Fourteenth Embodiment

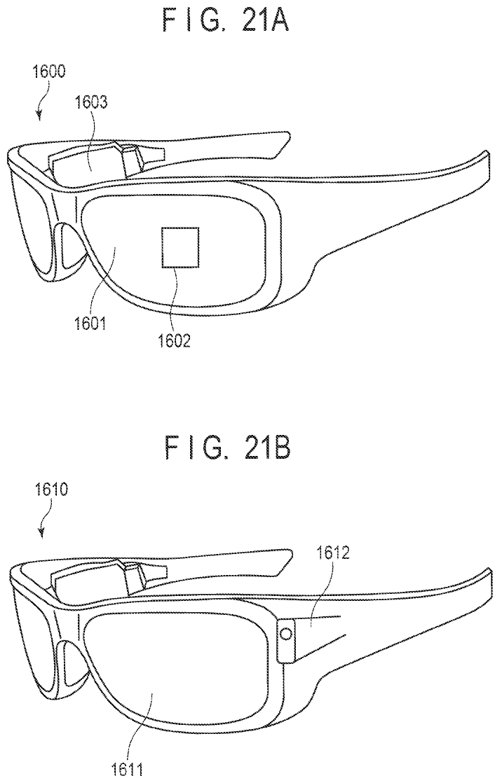

FIG. 21A is a diagram illustrating a specific example of an electronic device according to the present embodiment, and illustrates glasses 1600 (smart glasses). The glasses 1600 are provided with the photoelectric conversion device 1602 described in the above embodiments. That is, the glasses 1600 are an example of a photodetection system to which the photoelectric conversion device 1602 described in each of the above embodiments can be applied. A display device including a light emitting device such as an OLED or an LED may be provided on the back surface side of a lens 1601. One photoelectric conversion device 1602 or a plurality of photoelectric conversion devices 1602 may be provided. Further, a plurality of types of photoelectric conversion devices may be combined. The arrangement position of the photoelectric conversion device 1602 is not limited to that illustrated in FIG. 21A.

The glasses 1600 further comprise a control device 1603. The control device 1603 functions as a power source for supplying power to the photoelectric conversion device 1602 and the above-described display device. The control device 1603 controls operations of the photoelectric conversion device 1602 and the display device. The lens 1601 is provided with an optical system for collecting light to the photoelectric conversion device 1602.

FIG. 21B illustrates glasses 1610 (smart glasses) according to one application. The glasses 1610 include a control device 1612, and a photoelectric conversion device corresponding to the photoelectric conversion device 1602 and a display device are mounted on the control device 1612. The lens 1611 is arranged with a photoelectric conversion device in the control device 1612 and an optical system for projecting light emitted from a display device, and an image is projected on the lens 1611. The control device 1612 functions as a power source for supplying power to the photoelectric conversion device and the display device, and controls operations of the photoelectric conversion device and the display device. The control device 1612 may include a line-of-sight detection unit that detects the line of sight of the wearer. Infrared radiation may be used to detect the line of sight. The infrared light emitting unit emits infrared light to the eyeball of the user who is watching the display image. The reflected light of the emitted infrared light from the eyeball is detected by an imaging unit having a light receiving element, whereby a captured image of the eyeball is obtained. A reduction unit that reduces light from the infrared light emitting unit to the display unit in a plan view may be employed and the reduction unit reduces a degradation in image quality.

The control device 1612 detects the line of sight of the user with respect to the display image from the captured image of the eyeball obtained by imaging the infrared light. Any known method can be applied to the line-of-sight detection using the captured image of the eyeball. As an example, a line-of-sight detection method based on a Purkinje image due to reflection of irradiation light at a cornea can be used.

More specifically, a line-of-sight detection process based on a pupil cornea reflection method is performed. By using the pupil cornea reflection method, a line-of-sight vector representing a direction (rotation angle) of the eyeball is calculated based on the image of the pupil included in the captured image of the eyeball and the Purkinje image, whereby the line-of-sight of the user is detected.

The display device of the present embodiment may include a photoelectric conversion device having a light receiving element, and may control a display image of the display device based on line-of-sight information of the user from the photoelectric conversion device.

Specifically, the display device determines a first view field region gazed by the user and a second view field region other than the first view field region based on the line-of-sight information. The first view field region and the second view field region may be determined by a control device of the display device, or may be determined by an external control device. In the display area of the display device, the display resolution of the first view field region may be controlled to be higher than the display resolution of the second view field region. That is, the resolution of the second view field region may be lower than that of the first view field region.

The display area may include a first display region and a second display region different from the first display region. A region having a high priority may be determined from the first display region and the second display region based on the line-of-sight information. The first view field region and the second view field region may be determined by a control device of the display device, or may be determined by an external control device. The resolution of the high priority area may be controlled to be higher than the resolution of the region other than the high priority region. That is, the resolution of a region having a relatively low priority can be reduced.

It should be noted that an artificial intelligence (AI) may be used in determining the first view field region and the region with high priority. The AI may be a model configured to estimate an angle of a line of sight and a distance to a target on the line-of-sight from an image of an eyeball, and the AI may be trained using training data including images of an eyeball and an angle at which the eyeball in the images actually gazes. The AI program may be provided in either a display device or a photoelectric conversion device, or may be provided in an external device. When the external device has the AI program, the AI program may be transmitted from a server or the like to a display device via communication.

When the display control is performed based on the line-of-sight detection, the present embodiment can be preferably applied to a smart glasses which further includes a photoelectric conversion device for capturing an image of the outside. The smart glasses can display captured external information in real time.

### Modified Embodiments

The present disclosure is not limited to the above embodiment, and various modifications are possible. For example, an example in which some of the configurations of any one of the embodiments are added to other embodiments and an example in which some of the configurations of any one of the embodiments are replaced with some of the configurations of other embodiments are also embodiments of the present disclosure.

In the above-described embodiments, the photoelectric conversion device is exemplified as an example of the reading circuit 23 including the TDC, but it is not limited thereto. The above-described embodiments can be widely applied to a semiconductor device including a plurality of TDCs.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A B) is omitted. This is because it is assumed that “A is not B” is considered when “A is B” is described.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present disclosure, and the technical scope of the present disclosure should not be construed as being limited by the embodiments. That is, the present disclosure can be carried out in various forms without departing from the technical idea or the main features thereof.

According to the present disclosure, there is provided a semiconductor device capable of appropriately obtaining information on a systematic error.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of priority from Japanese Patent Application No. 2023-014111, filed Feb. 1, 2023, which is hereby incorporated by reference herein in its entirety.

What is claimed is:

1. A semiconductor device comprising:
a plurality of time-to-digital converters each including an input terminal, an output terminal, and a control terminal; and
a control signal line connected to the control terminal of a first time-to-digital converter among the plurality of time-to-digital converters, the control terminal of a second time-to-digital converter among the plurality of time-to-digital converters, and the input terminal of the first time-to-digital converter,
wherein a control signal propagating through the control signal line is input to the control terminal of the second time-to-digital converter at a time later than a time when the control signal is input to the control terminal of the first time-to-digital converter, and is input to the input terminal of the first time-to-digital converter at a time later than the time when the control signal is input to the control terminal of the second time-to-digital converter.

2. The semiconductor device according to claim 1, wherein the control signal includes a measurement start signal controlling a time at which each of the plurality of time-to-digital converters starts measurement.

3. The semiconductor device according to claim 1, wherein the control signal includes a clock signal indicating a reference in time measurement performed by the plurality of time-to-digital converters.

4. The semiconductor device according to claim 1, wherein the first time-to-digital converter outputs, from the output terminal, a first digital signal indicating a time from when the control signal is input from the control signal line to the control terminal to when the control signal is input from the control signal line to the input terminal.

5. The semiconductor device according to claim 4, wherein the first digital signal indicates a delay time at which the control signal propagates through the control signal line.

6. The semiconductor device according to claim 1 further comprising a plurality of first pixels arranged in a plurality of rows and a plurality of columns, each of the plurality of first pixels outputting a signal corresponding to incident light, wherein a part of the plurality of time-to-digital converters is arranged corresponding to the plurality of columns.

7. The semiconductor device according to claim 6, wherein the part of the plurality of time-to-digital converters includes the second time-to-digital converter, and does not include the first time-to-digital converter.

8. The semiconductor device according to claim 7, wherein the second time-to-digital converter outputs, from the output terminal, a second digital signal indicating a time from when the control signal is input to the control terminal to when the signal from the first pixel of the corresponding column is input to the input terminal.

9. The semiconductor device according to claim 8, wherein the second digital signal indicates a distance from the semiconductor device to an object.

10. The semiconductor device according to claim 6,
wherein the plurality of time-to-digital converters are arranged in one direction, and
wherein the control signal line is arranged to reciprocate in a direction in which the plurality of time-to-digital converters are arranged.

11. The semiconductor device according to claim 10,
wherein the control signal line has a first part that is a forward path in a direction in which the plurality of time-to-digital converters are arranged, and a second part that is a backward path in a direction in which the plurality of time-to-digital converters are arranged, and
wherein the control terminal of the first time-to-digital converter is connected to the first part.

12. The semiconductor device according to claim 11,
wherein the control terminal of the second time-to-digital converter is connected to the first part, and
wherein a dummy logic circuit is connected to the second part.

13. The semiconductor device according to claim 11, wherein a part of the control terminals of the plurality of time-to-digital converters are connected to the second part.

14. The semiconductor device according to claim 6 further comprising a plurality of second pixels arranged in a plurality of rows, each of the plurality of the second pixels not outputting a signal corresponding to incident light, wherein the control signal line is connected to the control terminal of a third time-to-digital converter among the plurality of time-to-digital converters and the plurality of second pixels.

15. The semiconductor device according to claim 14, wherein the third time-to-digital converter is included in one of the plurality of second pixels.

16. The semiconductor device according to claim 14, wherein the first time-to-digital converter is included in one of the plurality of second pixels.

17. The semiconductor device according to claim 14 further comprising a tree wiring,
wherein the control signal line is distributed to each row of the plurality of second pixels via the tree wiring.

18. The semiconductor device according to claim 14, wherein a part of the control signal line is arranged along a row of the plurality of second pixels so as to supply the control signal to the second pixels of two rows.

19. The semiconductor device according to claim 14,
wherein the plurality of first pixels and the plurality of second pixels are arranged in a plurality of rows and a plurality of columns, and
wherein pixels in at least one row of the plurality of rows is all the second pixels.

20. The semiconductor device according to claim 1,
wherein a photoelectric conversion element generating a signal input to one of the plurality of time-to-digital converters is arranged in a first substrate, and
wherein the plurality of time-to-digital converters are arranged in a second substrate.

21. A photo detection system comprising:
the semiconductor device according to claim 1; and
a signal processing unit configured to process a signal output from the semiconductor device.

22. A movable body comprising:
a movable body;
the semiconductor device according to claim 1;
a distance information acquisition unit configured to acquire distance information to an object by a signal output from the semiconductor device; and
a control unit configured to control the movable body based on the distance information.
